(19) United States
(12) Patent Application Publication
(10) Pub. No.: US 2020/0285056 A1
(43) Pub. Date: Sep. 10, 2020

(54) APPARATUS, SYSTEMS, AND METHODS FOR WEARABLE HEAD-MOUNTED DISPLAYS

(71) Applicant: Facebook Technologies, LLC, Menlo Park, CA (US)

(72) Inventor: Oskar Linde, San Carlos, CA (US)

(21) Appl. No.: 16/655,492

(22) Filed: Oct. 17, 2019

Related U.S. Application Data
(60) Provisional application No. 62/814,249, filed on Mar. 5, 2019.

(51) Int. Cl. G02B 27/01; G06F 3/01

(52) U.S. Cl. CPC G02B 27/0172; G02B 2027/0125; G02B 2027/0138; G06F 3/012

(57) ABSTRACT

An apparatus for wearable head-mounted displays may include a head-mounted display that includes (i) four lateral cameras, including (a) a camera that is mounted on a right side of the head-mounted display, (b) a camera that is mounted on a left side of the head-mounted display, (c) a camera that is mounted on a front of the head-mounted display and is right of a center of the front of the head-mounted display, and (e) a camera that is mounted on the front of the head-mounted display and is left of a center of the front of the head-mounted display, (ii) one central camera that is mounted on the front of the head-mounted display, and (iii) at least one display surface that displays visual data to a wearer of the head-mounted display. Various other apparatuses, systems, and methods are also disclosed.

### CROSS REFERENCE TO RELATED APPLICATION

This application claims the benefit of U.S. Provisional Application No. 62/814,249, filed 5 Mar. 2019, the disclosure of which is incorporated, in its entirety, by this reference.

### BACKGROUND

Augmented reality experiences, where virtual objects are projected onto or overlie real landscapes, and virtual reality experiences, where a user is surrounded in an entirely virtual world, are becoming increasingly popular. One common form factor for augmented and virtual reality experiences is a wearable headset with a screen that displays the augmented or virtual world to the wearer. Augmented reality headsets and virtual reality headsets may use motion tracking to accurately place the user in their environment and display the correct objects and trigger the right cues for the user's location. One method of motion tracking involves placing cameras on the headset to identify visual cues to location as well as track the movement of one or more controllers held by the user.

Unfortunately, traditional systems of motion tracking have various flaws. Many camera configurations leave gaps in camera coverage where a user can move the controller without the controller being visible to the cameras. Some ways of positioning a pair of controllers may cause one to occlude the other, temporarily removing the second controller from view. Some ways of affixing cameras to headsets may be unsightly or lack durability. Accordingly, the instant disclosure identifies and addresses a need for additional and improved camera configurations on wearable headsets. Additionally, the instant disclosure identifies and addresses a need for improved transmission of data from multiple cameras attached to the same device, such as a wearable headset.

### SUMMARY

As will be described in greater detail below, the instant disclosure describes apparatuses, systems, and methods for wearable head-mounted displays that provide motion tracking and/or controller tracking via five cameras mounted on various outer surfaces of the head-mounted display that transmit video streams over limited-bandwidth connections in the form of images.

In some embodiments, an apparatus for wearable head-mounted displays may include a head-mounted display that includes (i) four lateral cameras, including (a) a camera that is mounted on a right side of the head-mounted display, (b) a camera that is mounted on a left side of the head-mounted display, (c) a camera that is mounted on a front of the head-mounted display and is right of a center of the front of the head-mounted display, and (e) a camera that is mounted on the front of the head-mounted display and is left of a center of the front of the head-mounted display, (ii) one central camera that is mounted on the front of the head-mounted display, and (iii) at least one display surface that displays visual data to a wearer of the head-mounted display.

In one embodiment, the camera that is mounted on the left side of the head-mounted display may be angled downward relative to the camera that is mounted on the front of the head-mounted display and is left of a center of the front of the head-mounted display and/or the camera that is mounted on the right side of the head-mounted display may be angled downward relative to the camera that is mounted on the front of the head-mounted display and is right of a center of the front of the head-mounted display. In some embodiments, the central camera may be mounted higher on the front of the head-mounted display than the camera that is mounted on the front of the head-mounted display and is left of a center of the front of the head-mounted display.

In some embodiments, the central camera may be mounted on the head-mounted display via a non-rigid mounting. In one embodiment, the four lateral cameras may be mounted on the head-mounted display via a rigid mounting bracket. In some examples, the four lateral cameras may be mounted on the head-mounted display via at least one rigid mounting, a field of view of the four lateral cameras may overlap with a field of view of the central camera, the head-mounted display may send data from the field of view of the four lateral cameras to a system that corrects visual disturbances caused by the non-rigid mounting of the central camera using the data from the field of view of the four lateral cameras that overlaps with the field of view of the central camera.

In one example, the display surface of the head-mounted display may display the visual data to the wearer based at least in part on a position of the head-mounted display within a physical environment and at least one of the four lateral cameras and the central camera may capture visual environmental data that indicates the position of the head-mounted display within the physical environment. In some examples, at least one of the four lateral cameras and the central camera may track the position of a controller operated by the wearer of the head-mounted display. Additionally or alternatively, at least one of the four lateral cameras and the central camera may track the position of one or both hands of the wearer of the head-mounted display.

In one embodiment, each of the four lateral cameras may be mounted parallel to a surface of the head-mounted display to which the camera is mounted. In some embodiments, the front of the head-mounted display may at least partially cover the face of the wearer of the head-mounted display, the right side of the head-mounted display may be adjacent to the front of the head-mounted display, and/or the left side of the head-mounted display may be adjacent to the front of the head-mounted display opposite the right side of the head-mounted display.

In some embodiments, a system for wearable head-mounted displays may include a head-mounted display that includes five cameras that include (i) four lateral cameras including (a) a camera that is mounted on a right side of the head-mounted display, (b) a camera that is mounted on a left side of the head-mounted display, (c) a camera that is mounted on a front of the head-mounted display and is right of a center of the front of the head-mounted display, and (d) a camera that is mounted on a front of the head-mounted display and is left of a center of the front of the head-mounted display, and (ii) one central camera that is mounted on a front of the head-mounted display. In some embodiments, the system may also include at least one display surface that displays visual data to a wearer of the head-mounted display and an augmented reality system that receives visual data input from at least one of the five cameras and sends visual data output to the display surface of the head-mounted display.

In some embodiments, augmented reality system may receive the visual data input from the at least one of the five cameras and sends the visual data output to the display surface of the head-mounted display by combining streaming visual data input received from all five of the five cameras into combined visual data and displaying at least a portion of the combined visual data on the display surface of the head-mounted display. In some examples, the augmented reality system may receive the visual data input from the at least one of the five cameras by receiving visual data from the central camera that includes a visual disturbance due to the non-fixed mounting of the central camera, receiving visual data from at least one of the four lateral cameras that does not include the visual disturbance due to a fixed mounting of the at least one of four lateral cameras, and correcting for the visual disturbance in the visual data from the central camera using the visual data from the at least one of the four lateral cameras.

In one embodiment, the augmented reality system may identify a controller apparatus within the visual data input, determine, based on at least one visual cue within the visual data input, a position of the controller apparatus relative to the wearer of the head-mounted display, and perform an augmented reality action based at least in part on the position of the controller apparatus relative to the wearer of the head-mounted display. Additionally or alternatively, the augmented reality system may identify a physical location cue within visual data input from at least two cameras of the five cameras, determine a physical location of the wearer of the head-mounted display based at least in part on triangulating the physical location cue within the visual data input from the at least two cameras, and perform an augmented reality action based at least in part on the physical location of the wearer of the head-mounted display.

In some examples, the augmented reality system may (i) identify a first controller apparatus and a second controller apparatus, (ii) determine that the first controller apparatus is visually occluded by the second controller apparatus in visual data input from one camera of the five cameras, (iii) determine that the first controller apparatus is not visually occluded by the second controller apparatus in visual data input from a different camera of the five cameras, (iv) determine a position of the first controller apparatus based at least in part on visual data from the different camera, and (v) perform an augmented reality action based at least in part on the position of the first controller apparatus. In some embodiments, for each camera within the five cameras, a field of view of the camera may overlap at least partially with a field of view of at least one additional camera within the five cameras.

In some embodiments, a computer-implemented method for motion tracking head-mounted displays may include (i) identifying a head-mounted display that includes five cameras, where one of the five cameras is attached to a right side of the head-mounted display, one of the five cameras is attached to a left side of the head-mounted display, one of the five cameras is attached to centrally on a front of the head-mounted display, and two of the five cameras are attached laterally on the front of the head-mounted display, (ii) capturing, via at least one camera of the five cameras, visual data of a physical environment surrounding a wearer of the head-mounted display, (iii) determining, based on the visual data of the physical environment captured by the at least one camera, a position of the wearer of the head-mounted display relative to the physical environment, and (iv) performing an action based on the position of the wearer of the head-mounted display relative to the physical environment.

In some embodiments, performing the action may include displaying a virtual object on a display surface of the head-mounted display. In some examples, the method may further include determining, based on the visual data of the physical environment captured by the at least one camera, a position of a controller apparatus, and performing an action based on the position of the controller apparatus.

In one example, a computer-implemented method for efficiently transmitting data from cameras may include (i) identifying at least two streams of video data that are each produced by a different camera, (ii) receiving a set of at least two frames of video data that includes exactly one frame from each of the at least two streams of video data, (iii) placing, within an image, the set of at least two frames of video data received from the at least two streams of video data, and (iv) transmitting the image that includes the set of at least two frames of video data received from the at least two streams of video data via a single transmission channel.

In one embodiment, placing, within the image, the set of at least two frames of video data may include arranging each frame of video data within the set of at least two frames of video data within the image based at least in part on a characteristic of the frame of video data. In one example, the characteristic may include a readout start time of the frame of video data. Additionally or alternatively, the characteristic may include an exposure length of the frame of video data. In one embodiment, arranging each frame of video data within the image based at least in part on the characteristic of the frame of video data may include arranging each frame of video data side by side horizontally across the image such that the vertical placement of each frame of video data within the image corresponds to the characteristic.

In one embodiment, placing, within the image, the set of at least two frames of video data may include encoding metadata that describes the set of at least two frames of video data within the image. In some examples, encoding the metadata may include encoding a timestamp of each frame from the set of at least two frames of video data. In some examples, encoding the metadata may include encoding at least one camera setting used to create each frame from the set of at least two frames of video data. Additionally or alternatively, encoding the metadata may include encoding, for each frame from the set of at least two frames of video data, an identifier of a type of function being performed by a camera that recorded the frame.

In one embodiment, the at least two streams of video data may be produced by at least two cameras that each include a different exposure length. In some examples, transmitting the image via the single transmission channel may include transmitting the image via a transmission channel that has limited bandwidth. In some examples, transmitting the image via the single transmission channel may include transmitting the image via a cable.

In one embodiment, the at least two streams of video data may be produced by cameras that are coupled to a same device. In some examples, transmitting the image via the single transmission channel may include transmitting the image from a first component of a device to a second component of the device.

In one embodiment, placing, within the image, the set of at least two frames of video data received from the at least two streams of video data may include encoding the image via a default image encoder for at least one of a camera that produced one of the at least two streams of video data or a processor that processes the image.

In one embodiment, a system for implementing the above-described method may include at least one physical processor and physical memory that includes computer-executable instructions that, when executed by the physical processor, cause the physical processor to (i) identify at least two streams of video data that are each produced by a different camera, (ii) receive a set of at least two frames of video data that includes exactly one frame from each of the at least two streams of video data, (iii) place, within an image, the set of at least two frames of video data received from the at least two streams of video data, and (iv) transmit the image that includes the set of at least two frames of video data received from the at least two streams of video data via a single transmission channel.

In some examples, the above-described method may be encoded as computer-readable instructions on a non-transitory computer-readable medium. For example, a computer-readable medium may include one or more computer-executable instructions that, when executed by at least one processor of a computing device, may cause the computing device to (i) identify at least two streams of video data that are each produced by a different camera, (ii) receive a set of at least two frames of video data that includes exactly one frame from each of the at least two streams of video data, (iii) place, within an image, the set of at least two frames of video data received from the at least two streams of video data, and (iv) transmit the image that includes the set of at least two frames of video data received from the at least two streams of video data via a single transmission channel.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an illustration of two exemplary areas of coverage of two different exemplary head-mounted displays.

FIG. 2 is an illustration of two exemplary areas of non-covered space of two different exemplary ample head-mounted displays.

FIG. 3 is an isomorphic view of an exemplary head-mounted display.

FIG. 4 is an additional isomorphic view of an exemplary head-mounted display.

FIG. 5 is a left-side view of an exemplary head-mounted display.

FIG. 6 is a right-side view of an exemplary head-mounted display.

FIG. 7 is an isomorphic right-side of an exemplary head-mounted display.

FIG. 8 is a front view of an exemplary head-mounted display.

FIG. 9 is a back view of an exemplary head-mounted display.

FIG. 10 is a top view of an exemplary head-mounted display.

FIG. 11 is a bottom view of an exemplary head-mounted display.

FIG. 12 is an illustration of an exemplary head-mounted display in context.

FIG. 13 is a block diagram of an exemplary system for processing video data for transmission over limited-bandwidth channels.

FIG. 14 is a block diagram of an exemplary system for processing visual data for wearable head-mounted displays.

FIG. 15 is a flow diagram of an exemplary method for transmitting video stream data efficiently.

FIG. 16 is a flow diagram of an exemplary method for processing visual data for wearable head-mounted displays.

FIG. 17 is a block diagram of exemplary exposures and readouts for cameras.

FIG. 18 is a block diagram of an exemplary image that includes camera frames.

FIG. 19 is a flow diagram of an exemplary method for processing visual data for wearable head-mounted displays.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to apparatuses, systems, and methods for wearable head-mounted displays. As will be explained in greater detail below, embodiments of the instant disclosure may improve the effectiveness of motion tracking and/or controller tracking for a wearable head-mounted display by constructing the head-mounted display with five cameras, four located laterally and one located centrally. In some embodiments, constructing the head-mounted display with five cameras (rather than a smaller number, such as four cameras) may increase the coverage area of the cameras and/or decrease dead space that is not covered by any camera. In some examples, increasing the areas where the fields of view of two or more cameras overlap may enable the systems described herein to improve tracking of controllers in situations where one controller might occlude the view of the other and/or reduce the impact of visual disturbances in the feed from any one camera. Additionally, constructing a head-mounted display with five cameras may enable the cameras to be placed flush to the surfaces on which the cameras are mounted, improving the durability and/or aesthetics of the head-mounted display over head-mounted displays with cameras affixed at the corners and/or other positions that are not flush with the surface of the head-mounted display. In some examples, the apparatuses, systems, and methods described herein may improve the field of augmented reality by improving the ability of an augmented reality system to locate a user and/or controller in order to provide accurate augmented reality content based on the position of the user and/or controller. Additionally, the apparatuses, systems, and methods described herein may improve the functioning of a computing device by improving the coverage and/or quality of visual input processed by the computing device.

In some embodiments, cameras on a wearable head-mounted display or other device with multiple cameras (e.g., other wearable device, vehicle, drone, etc.) may transmit streaming video data to other components of the same device and/or to other devices via a single communication channel. In some examples, this communication channel may have limited bandwidth, such as a wireless link or a universal services bus cable. By combining frames from multiple video streams into a single image that also includes metadata and then transmitting that image, the systems and methods described herein may more efficiently transmit data recorded by video cameras over limited-bandwidth channels. In some embodiments, the systems described herein may create images that can be encoded and decoded by standard decoders, improving interoperability. Additionally, the systems described herein may reduce the use of computing resources (such as energy expenditure) compared to methods involving frame buffers, improving the functioning of low-power devices such as headsets. In some examples, the systems and methods described herein may improve the field of video streaming by transmitting video data more efficiently. Additionally, the systems and methods described herein may improve the functioning of a computing device by reducing the resources required to transmit data recorded by multiple video cameras.

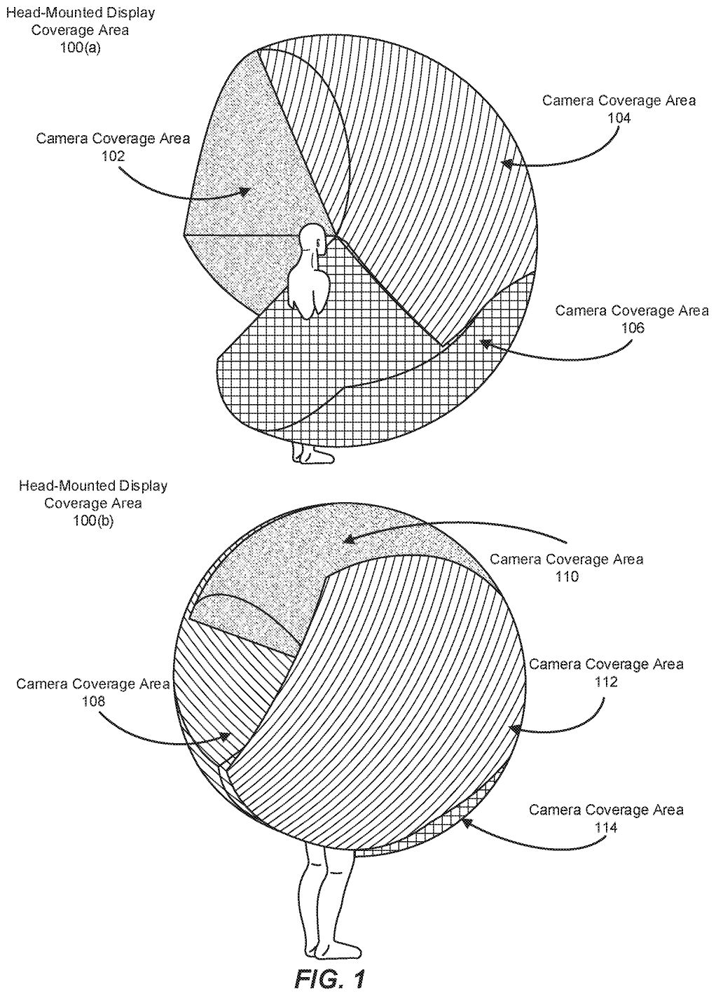

FIG. 1 is an illustration of two exemplary areas of coverage of two different exemplary head-mounted displays. The term “head-mounted display,” as used herein, generally refers to any wearable device that is worn on the head of the wearer and includes at least one display surface that displays visual data to the wearer. In some embodiments, a head-mounted display may include cameras mounted on outer surfaces with fields of view that collectively create a camera coverage area in space around the head-mounted display. In some examples, a head-mounted display coverage area 100(a) may illustrate the camera coverage area of a head-mounted display with four cameras. In one example, head-mounted display coverage area 100(a) may be composed of camera coverage areas 102, 104, and/or 106, and/or an additional camera coverage area opposite camera coverage area 106. In some examples, head-mounted display coverage area 100(a) may have gaps in front of a wearer's face and/or around a wearer's shoulders. In one example, these coverage gaps may prevent the head-mounted display from accurately tracking the motion of a controller when the wearer holds the controller above the wearer's shoulder.

In some embodiments, a head-mounted display coverage area 100(b) may include camera coverage areas 108, 110, 112, and/or 114, and/or an additional camera coverage area opposite camera coverage area 112. In some examples, head-mounted display coverage area 100(b) may cover the area around the wearer's shoulders and head, accurately capturing the locations of any controllers moved into that area. In some embodiments, a head-mounted display with five cameras such as the head-mounted display that produces head-mounted display coverage area 100(b) may offer significantly improved coverage over a head-mounted display with four cameras such as the head-mounted display that produces head-mounted display coverage area 100(a).

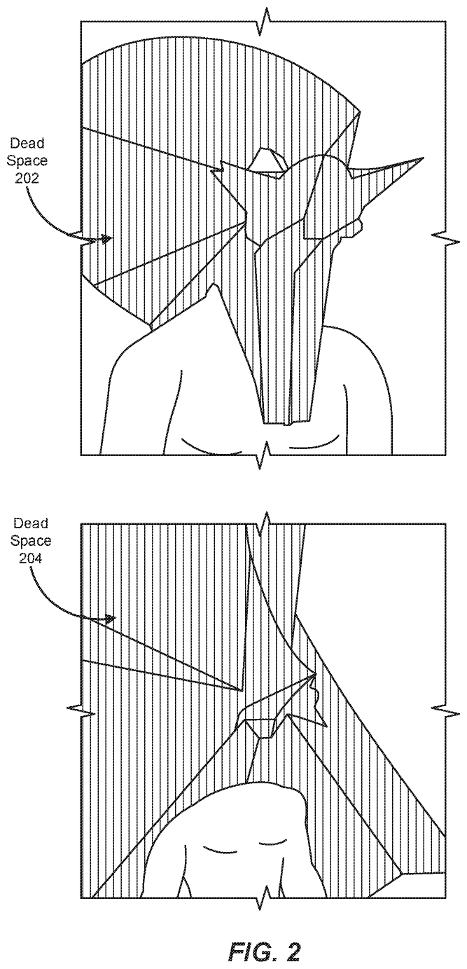

FIG. 2 is an illustration of two exemplary areas of non-covered space of two different exemplary ample head-mounted displays. In one embodiment, a head-mounted display with four cameras (such as the display that produces head-mounted display coverage area 100(a) in FIG. 1) may generate an area of dead space 202 where there is no camera coverage. In some examples, controllers, environmental features, and/or other objects in dead space 202 may not be captured by any cameras of a head-mounted display, preventing an augmented reality system from accurately responding to the presence and/or location of those objects and/or features. In some embodiments, a head-mounted display with five cameras (such as the display that produces head-mounted display coverage area 100(b) in FIG. 1) may generate dead space 204. In some examples, dead space 204 may cover less and/or less important (e.g., in terms of likelihood of controllers and/or other objects that are significant to an augmented reality system occupying that space) space than dead space 202.

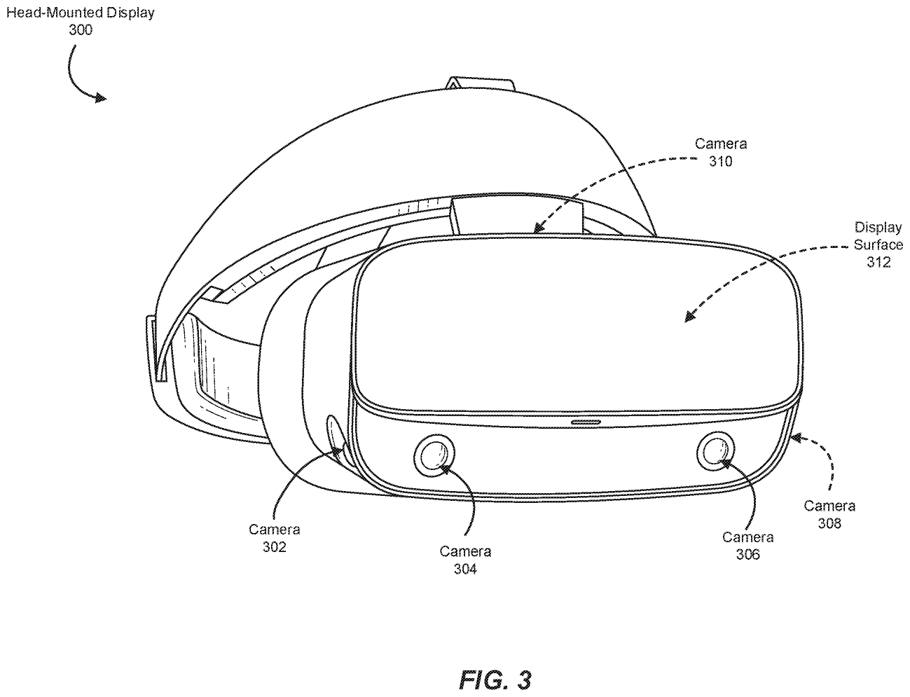

FIG. 3 is an illustration of an exemplary head-mounted display. In some embodiments, a head-mounted display 300 may include cameras 302, 304, 306, 308, and/or 310, and/or a display surface 312. In some embodiments, camera 302 may be mounted on the right surface of head-mounted display 300, camera 308 may be mounted on the left surface of head-mounted display 300, camera 304 may be mounted on the right side of the front, camera 306 may be mounted on the left side of the front, and/or camera 310 may be mounted centrally on the front of head-mounted display 300. In some embodiments, cameras 302, 304, 306, and/or 308 may be mounted on rigid mounting points while camera 310 may be mounted on a non-rigid mounting point. In one embodiment, cameras 302, 304, 306, and/or 308 may be mounted to a metal bracket set within head-mounted display 300.

In some embodiments, cameras 302, 304, 306, 308, and/or 310 may each be mounted flush with surfaces of head-mounted display 300 (rather than protruding from head-mounted display 300). In one embodiment, camera 302 may be located behind camera 304 (relative to the front of head-mounted display 300) and/or may be angled at a downward angle, such as 45° downward. In some embodiments, camera 302 may be located at a different downward angle, such as 30°, 60°, or any other appropriate angle. Similarly, camera 308 may be located behind camera 306 and/or may be angled at a downward angle. In some embodiments, cameras 304, 306, and 310 may all be mounted on the same surface of the head-mounted display. In other embodiments, cameras 304 and/or 306 may be mounted on one front surface of the head-mounted display while camera 310 may be mounted on a separate front surface of the head-mounted display.

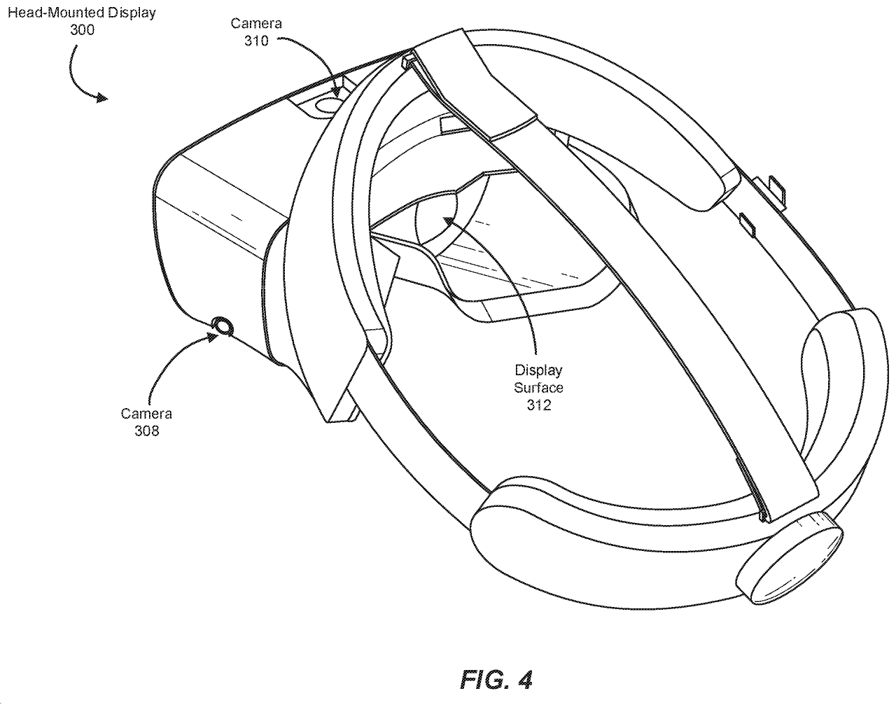

FIG. 4 is an illustration of head-mounted display 300 as seen from above and behind. As illustrated in FIG. 4, in some embodiments, camera 310 may be mounted on the top of the front of head-mounted display 300 perpendicular to cameras 304 and/or 306. In one embodiment, camera 308 may be mounted on the side of head-mounted display 300. In some embodiments, display surface 312 may be a combined display surface visible to both of the wearer's eyes. Additionally or alternatively, display surface 312 may include separate lenses that are each positioned in front of one eye of the wearer of head-mounted display 300.

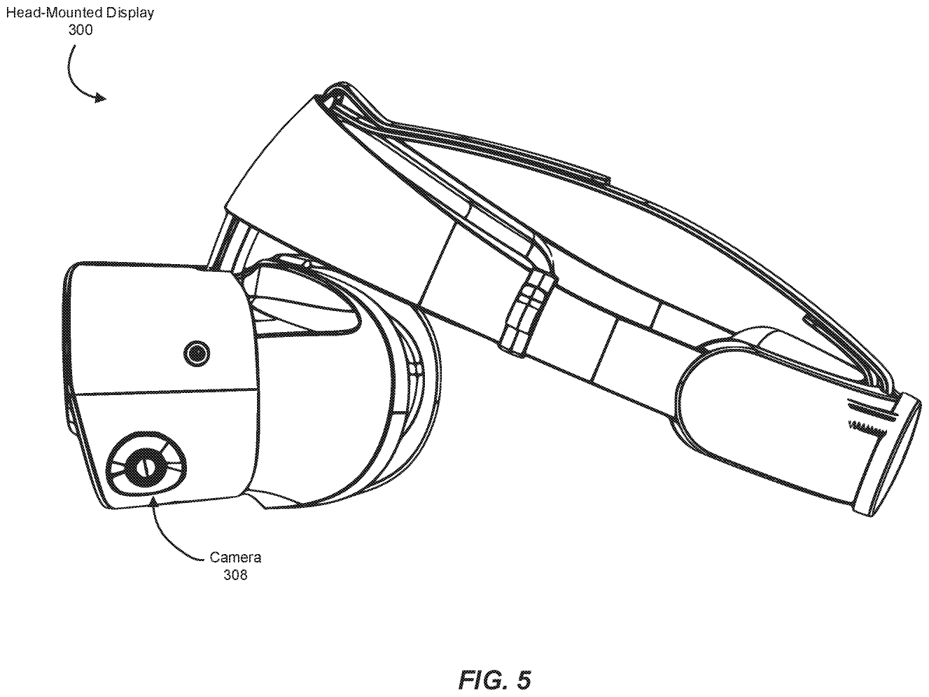

FIG. 5 is a left-side view of head-mounted display 300. As illustrated in FIG. 5, camera 308 may be mounted on the left side of head-mounted display 300. In some embodiments, camera 308 may be mounted towards the bottom of the left side and/or may be angled downward.

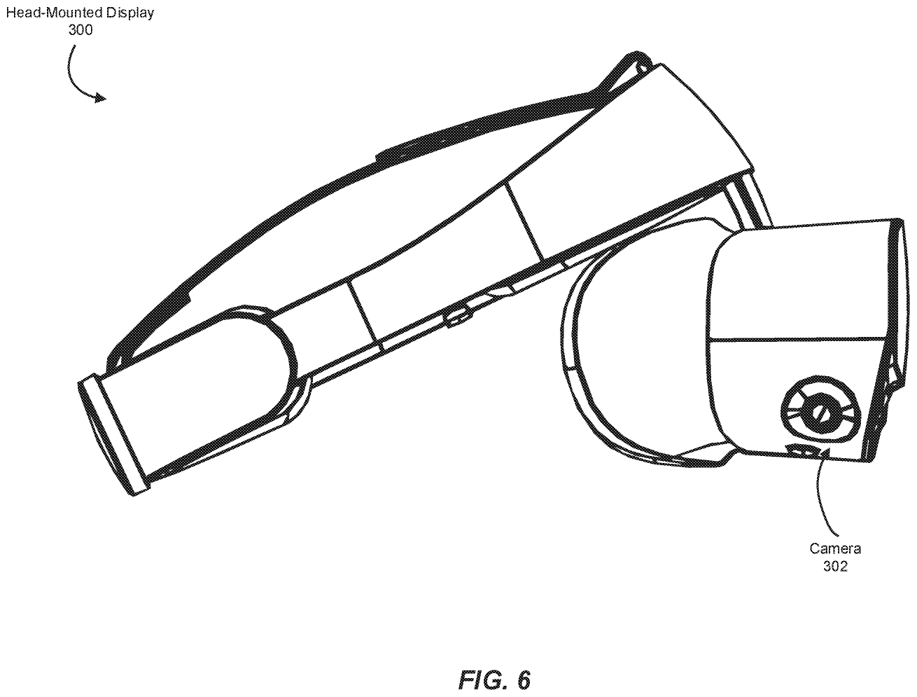

FIG. 6 is a right-side view of head-mounted display 300. As illustrated in FIG. 6, camera 302 may be mounted on the right side of head-mounted display 300. In some embodiments, camera 302 may be mounted towards the bottom of the right side and/or may be angled downward.

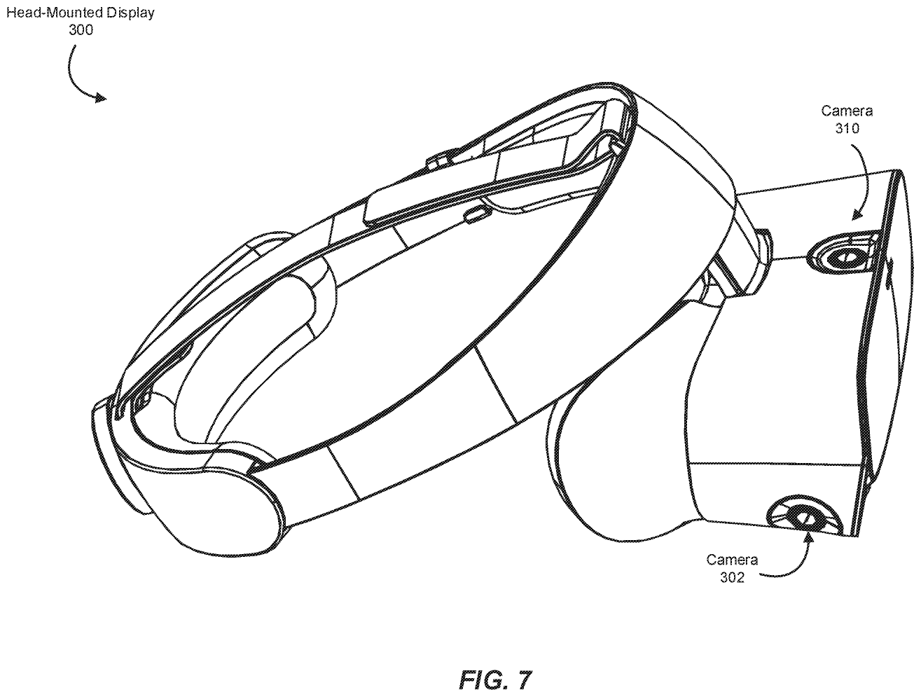

FIG. 7 is an isomorphic right-side of head-mounted display 300. As illustrated in FIG. 7, in some embodiments, camera 310 may be mounted on top of head-mounted display 300 at an obtuse angle to camera 302.

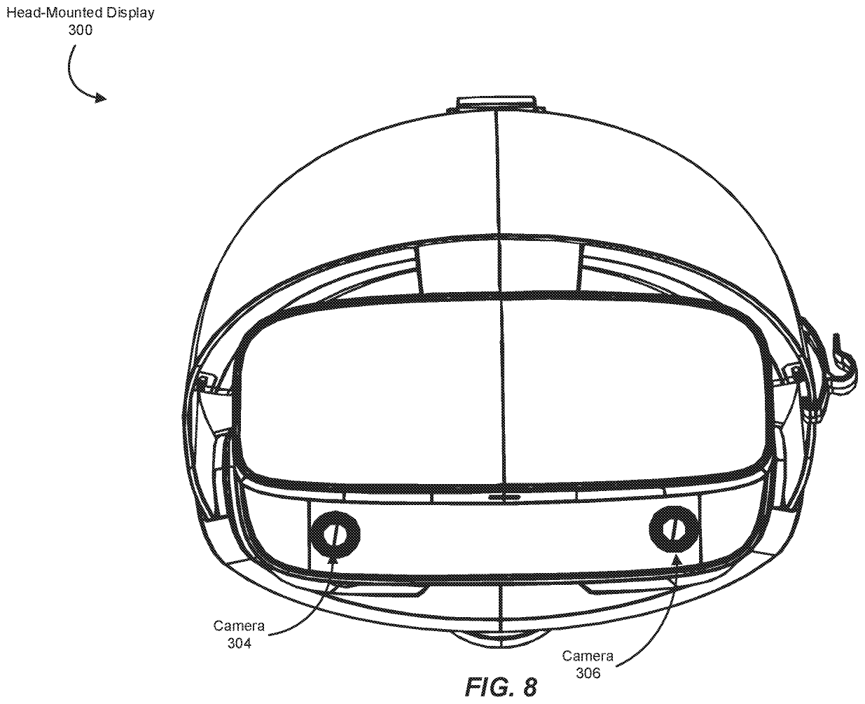

FIG. 8 is a front view of head-mounted display 300. As illustrated in FIG. 8, in some embodiments, cameras 304 and 306 may be mounted on the same front surface of head-mounted display 300. In one embodiment, camera 304 may be mounted towards the right side (according to the wearer) of head-mounted display 300 and/or camera 306 may be mounted towards the left side of head-mounted display 300.

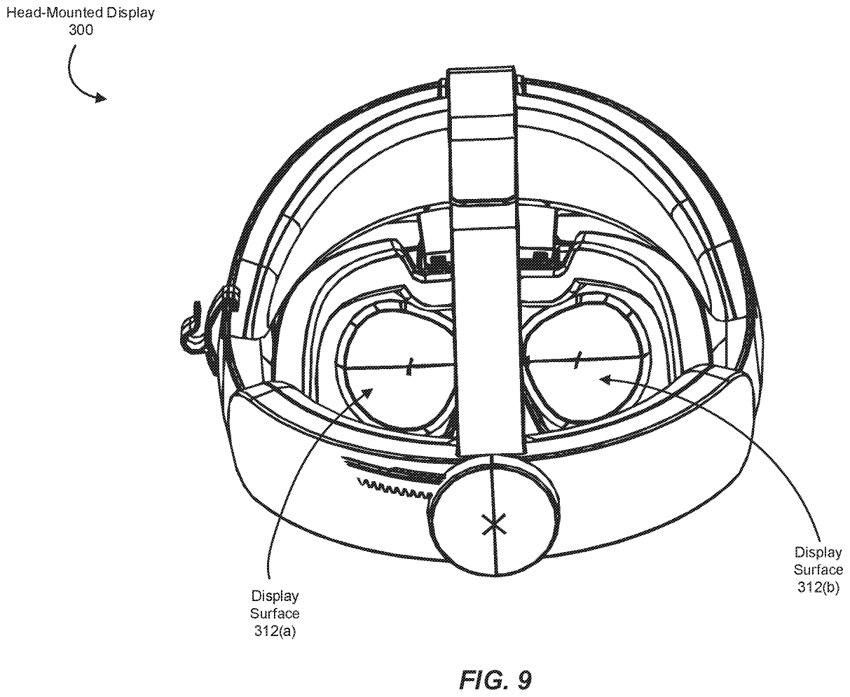

FIG. 9 is a back view of head-mounted display 300. As illustrated in FIG. 9, in some embodiments, display surface 312 may be divided into a display surface 312(a) and a display surface 312(b), with each portion of display surface 312 displaying images to one of the wearer's eyes.

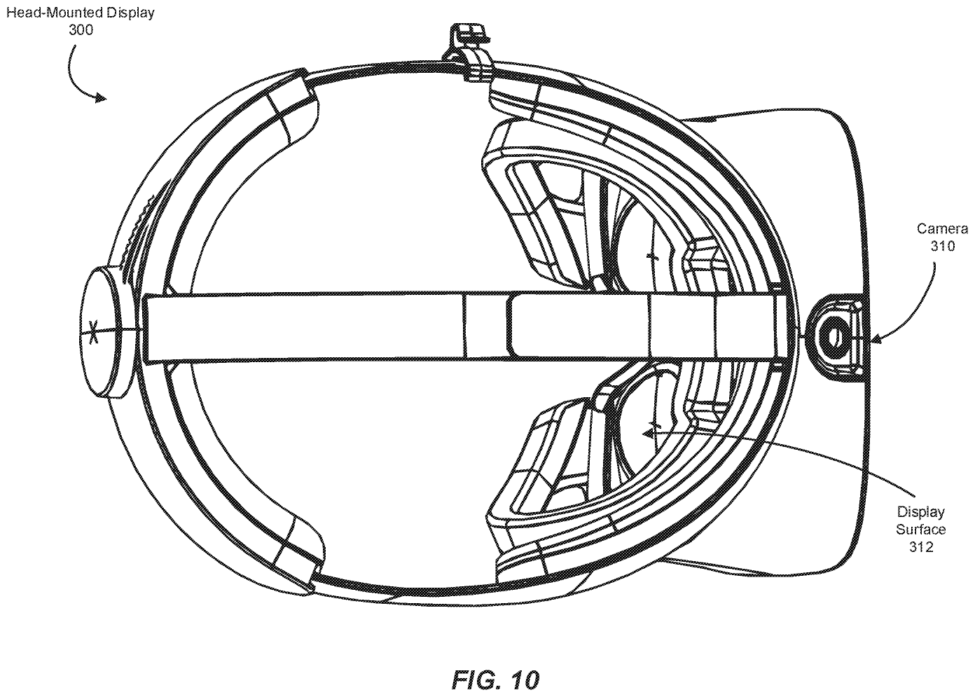

FIG. 10 is a top view of head-mounted display 300. As illustrated in FIG. 10, in some embodiments, camera 310 may be mounted on top of a component of head-mounted display 300 that also houses display surface 312.

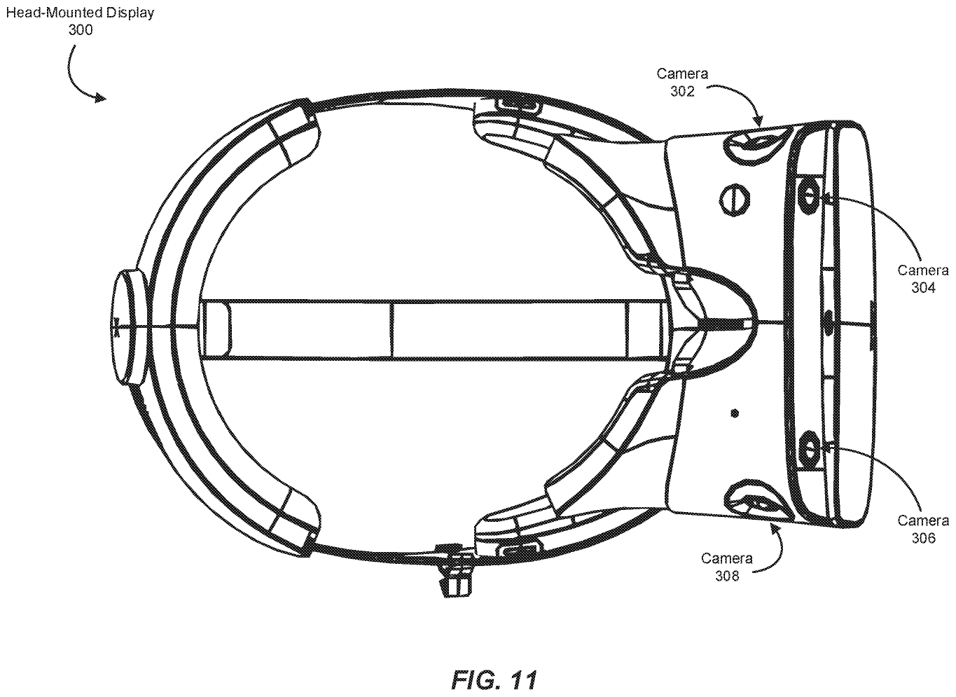

FIG. 11 is a bottom view of head-mounted display 300. As illustrated in FIG. 11, in some embodiments, camera 302 and/or camera 308 may be mounted and/or angled towards the bottom of head-mounted display 300. In one embodiment, camera 304 and/or camera 306 may be mounted at an angle to camera 302 and/or camera 308.

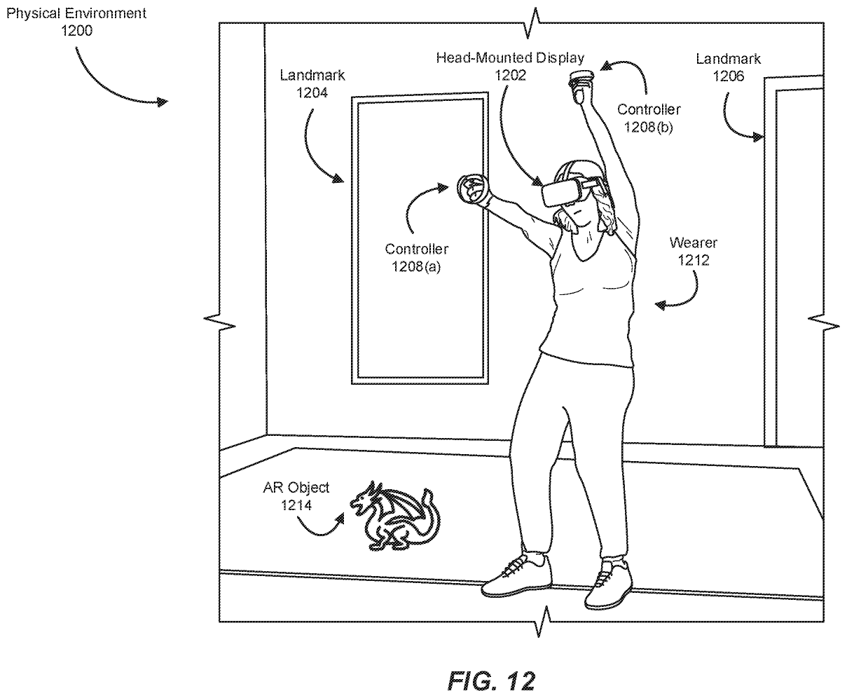

FIG. 12 is an illustration of an exemplary head-mounted display in context. In some examples, a wearer 1212 may wear a head-mounted display 1202 and/or hold a controller 1208(a) and/or a controller 1208(b). In one example, cameras on head-mounted display 1202 may identify a landmark 1204 and/or a landmark 1206 to determine the location of wearer 1212 within a physical environment 1200. In some embodiments, the systems described herein may use two or more cameras mounted on head-mounted display 1202 with overlapping fields of view to triangulate the location of landmark 1204 and/or landmark 1206. In one example, the systems described herein may use landmark 1204 and/or landmark 1206 to triangulate the location of wearer 1212.

In some examples, camera on head-mounted display 1202 may motion track controller 1208(a) and/or controller 1208(b). In one example, an augmented reality system may use information about the location of wearer 1212 and/or the locations of controllers 1208(a) and/or 1208(b) to display an augmented reality object 1214 on a display surface of head-mounted display 1202. In some examples, augmented reality object 1214 may appear to wearer 1212 to be situated within physical environment 1200 and/or the augmented reality system may use visual input data from cameras of head-mounted display 1202 to display a portion of physical environment 1200 on the display surface of head-mounted display 1202. In other examples, augmented reality object 1214 may appear to be situated within a virtual landscape entirely unrelated to physical environment 1200.

In some examples, the display surface of head-mounted display 1202 may display different augmented reality objects to wearer 1212 based on the location of wearer 1212 within physical environment 1200. For example, head-mounted display 1202 may only display augmented reality object 1214 when wearer 1212 is within a certain radius of the position of augmented reality object 1214. Additionally or alternatively, head-mounted display 1202 may display different augmented reality objects based on input received from controllers 1208(a) and/or 1208(b) including relative positions of controllers 1208(a) and/or 1208(b). For example, wearer 1212 may swing controller 1208(a) like a sword in order to control a virtual sword, and the augmented reality system may cease displaying augmented reality object 1214 in response to detecting that the virtual sword controlled by controller 1208(a) intersected with augmented reality object 1214 (e.g., because wearer 1212 has slain the dragon).

Additionally or alternatively, head-mounted display 1202 may display different augmented reality objects and/or environments based on the position of one or more hands of wearer 1212. In some embodiments, one or more of the cameras on head-mounted display 1202 may perform hand tracking on wearer 1212. In some embodiments, specific cameras, such as one lateral camera on each side of head-mounted display 1202, may collect image data used to perform the hand tracking. In one embodiment, the lateral cameras mounted on the front surface of head-mounted display 1202 may collect image data used to perform hand tracking. Additionally or alternatively, different cameras may enable hand tracking and/or other functions at different times. In some examples, the term “hand tracking,” as used herein, may generally refer to hand pose estimation across a time sequence (e.g., across a sequence of still images extracted from a video feed captured by a camera). Additionally or alternatively, hand tracking may include determining the three-dimensional pose of a user's hand, including the three-dimensional position of the hand, the orientation of the hand, and/or the configuration of the fingers of the hand. In some embodiments, the systems described herein may perform hand tracking in place of controller tracking. Additionally or alternatively, the systems described herein may perform hand tracking in addition to controller tracking. In some embodiment, the systems described herein may include a hand tracking module that receives data from one or more cameras of head-mounted display 1202 and determines the location of one or more hand features on a hand model using a machine learning algorithm such as a neural network. In some examples, the systems described herein may detect the position of a hand of wearer 1212 and then display the position of the hand on a screen of head-mounted display 1202. Additionally or alternatively, the systems described herein may change configuration settings (e.g., volume), perform virtual reality actions, and/or perform other actions in response to determining the position of one or both hands of wearer 1212.

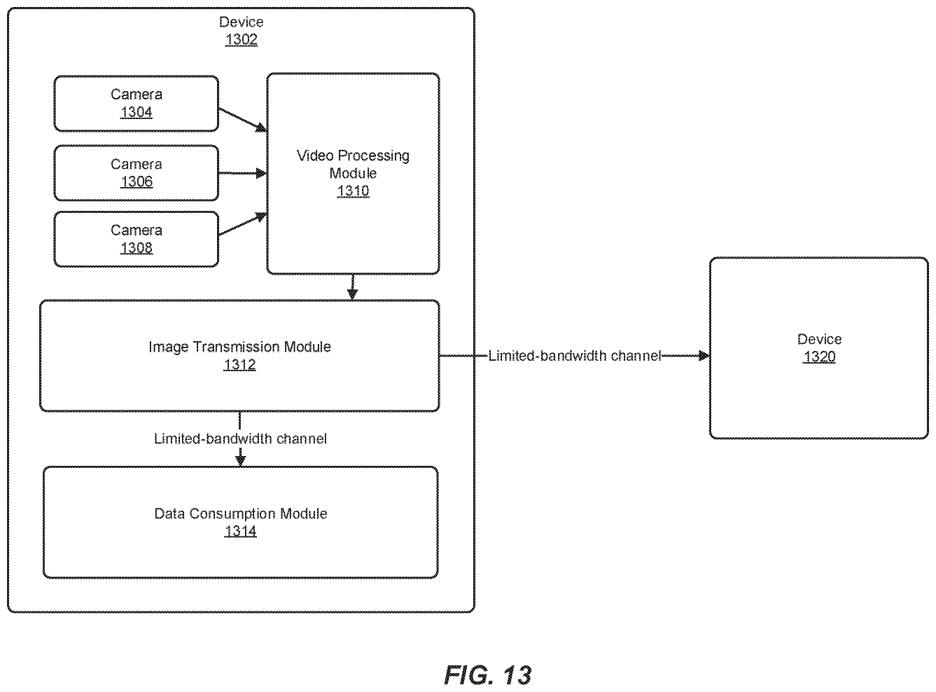

FIG. 13 is a block diagram of an exemplary system for processing video data into images for transmission over limited-bandwidth channels. In one embodiment, a device 1302 may include and/or receive data from multiple cameras, such as cameras 1304, 1306, and/or 1308. In some embodiments, device 1302 may be a head-mounted display. Additionally or alternatively, device 1302 may be another type of wearable device, a vehicle, and/or a drone. In one embodiment, a video processing module 1310 may receive streaming video data from cameras 1304, 1306, and/or 1308 and produce still images that each include at most one frame of video data from each camera. In some examples, video processing module 1310 may send data to an image transmission module 1312 that may transmit the still images via a limited-bandwidth channel. In one example, image transmission module 1312 may transmit the images to a data consumption module 1314 that is also hosted on device 1302. Data consumption module 1314 may perform various tasks relating to the data included in the images, such as constructing a combined video stream with images from different cameras and/or processing images to make determinations about information contained within the images. In some embodiments, image transmission module 1314 may send the images to data consumption module 1314 via a physical cable with limited bandwidth. Additionally or alternatively, image transmission module 1312 may transmit images to a device 1320 that is not physically coupled to device 1302. In some embodiments, device 1302 may represent, without limitation, a wearable device, a server, and/or a personal computing device. In one embodiment, transmission module 1312 may transmit the images via a wireless connection with limited bandwidth.

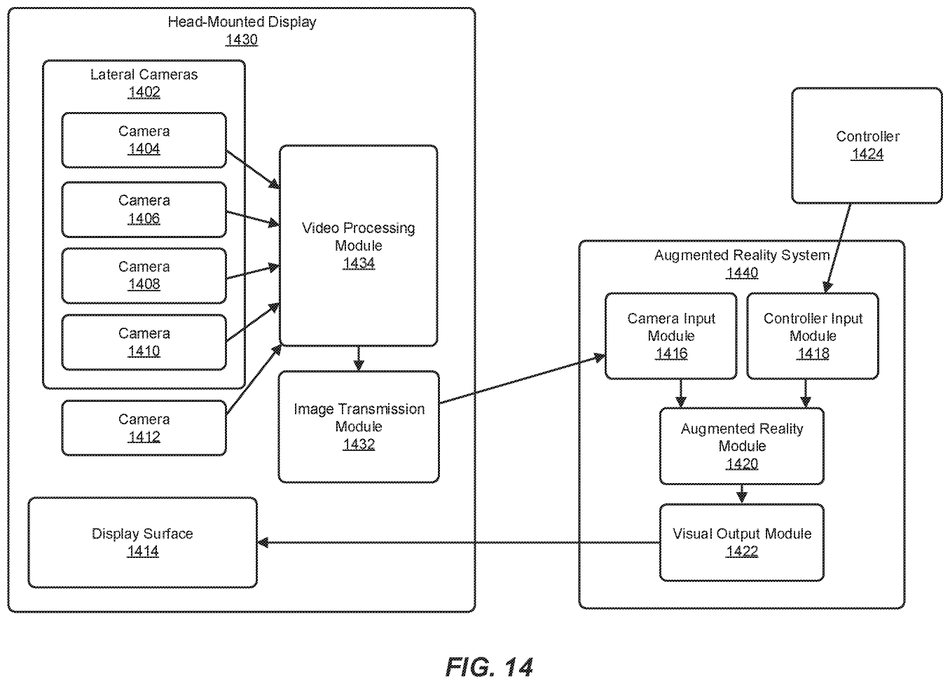

FIG. 14 is a block diagram of an exemplary system for processing visual data for wearable head-mounted displays. The term “visual data,” as used herein, generally refers to any data that can be captured by a camera. In some examples, visual data may include streaming video data. Additionally or alternatively, visual data may include recorded video data and/or still images. As illustrated in FIG. 14, a head-mounted display 1430 may include lateral cameras 1402, a central camera 1412, and/or a display surface 1414. In one embodiment, lateral cameras 1402 may include cameras 1404, 1406, 1408, and/or 1410. In one embodiment, a video processing module 1434 may receive streaming video data from cameras 1404, 1406, 1408, 1410, and/or 1412. In some embodiments, video processing module 1434 may process the streaming video data into a series of images that each include at most one frame from each camera stream. In some examples, the images may also include metadata about the camera frames. In one example, video processing module 1434 may then send each image to an image transmission module 1432 that transmits the images to other modules within head-mounted display 1430 and/or external modules.

In some embodiments, an augmented reality system 1440 may include a camera input module 1416 that receives data from image transmission module 1432, processes the data to extract relevant information (e.g., user location and/or controller position), and/or sends data to an augmented reality module 1420. In one embodiment, augmented reality system may also include a controller input module 1418 that receives input from a controller 1424 and sends data to augmented reality module 1420. In some embodiments, augmented reality module 1410 may send data to a visual output module 1422 that sends visual data to display surface 1414 of head-mounted display 1430. In some embodiments, some or all of augmented reality system 1440 may be hosted on modules located within head-mounted display 1430. Additionally or alternatively, some or all of augmented reality system 1440 may be hosted on a separate device such as a local server, a local gaming system, and/or a remote server.

In some embodiments, camera input module 1416 may process input data in a variety of ways. For example, camera 1412 may be mounted on a non-rigid mounting, causing visual data from camera 1412 to be blurry, originate from slightly different angles at different times (e.g., due to the bouncing of camera 1412), and/or include other visual disturbances. In some examples, camera input module 1416 may use visual data from cameras 1404, 1406, 1408, and/or 1410 to correct for visual disturbances in data from camera 1412. For example, camera 1404 may have a field of view that overlaps the field of view from camera 1412, and camera input module 1416 may use data from camera 1404 to correct for issues in data from camera 1412 originating from the portion of the field of view of camera 1412 that overlaps the field of view of camera 1404.

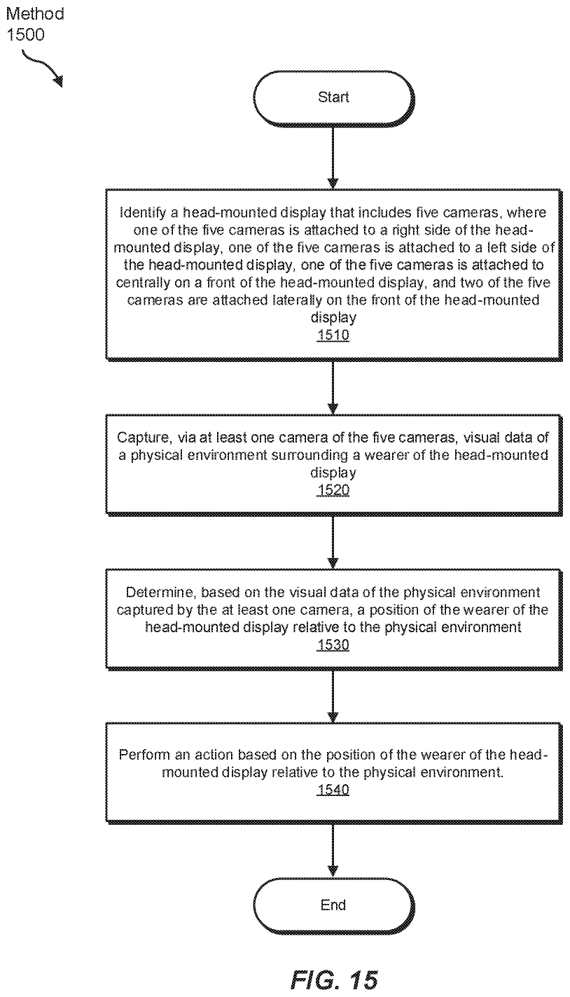

FIG. 15 is a flow diagram of an exemplary method 1500 for processing visual data for wearable head-mounted displays. At step 1510, one or more of the systems described herein may identify a head-mounted display that includes five cameras, where one of the five cameras is attached to a right side of the head-mounted display, one of the five cameras is attached to a left side of the head-mounted display, one of the five cameras is attached to centrally on a front of the head-mounted display, and two of the five cameras are attached laterally on the front of the head-mounted display. In some embodiments, the five cameras may have overlapping fields of view, be used for motion tracking of one or more controllers, and/or be used for location tracking of a wearer of the head-mounted display.

At step 1520, one or more of the systems described herein may capture, via at least one camera of the five cameras, visual data of a physical environment surrounding a wearer of the head-mounted display. In some embodiments, the systems described herein may capture video data of the physical environment.

At step 1530, one or more of the systems described herein may determine, based on the visual data of the physical environment captured by the at least one camera, a position of the wearer of the head-mounted display relative to the physical environment. Additionally or alternatively, the systems described herein may determine the position of one or more controllers relative to the wearer of the head-mounted display.

At step 1540, one or more of the systems described herein may perform an action based on the position of the wearer of the head-mounted display relative to the physical environment. For example, the systems described herein may begin or cease displaying one or more augmented reality objects, landscapes, and/or landscape features. In some examples, the systems described herein may activate and/or deactivate augmented reality effects (e.g., altering an augmented reality game character's stats based on a proximity effect of an in-game location), modify audio data (e.g., playing and/or stopping sound effects and/or music), and/or perform any other suitable action related to an augmented reality system. In one example, the systems described herein may display a warning upon detecting, based on the position of the wearer, that the wearer is too close to a wall, stairwell, and/or other dangerous object.

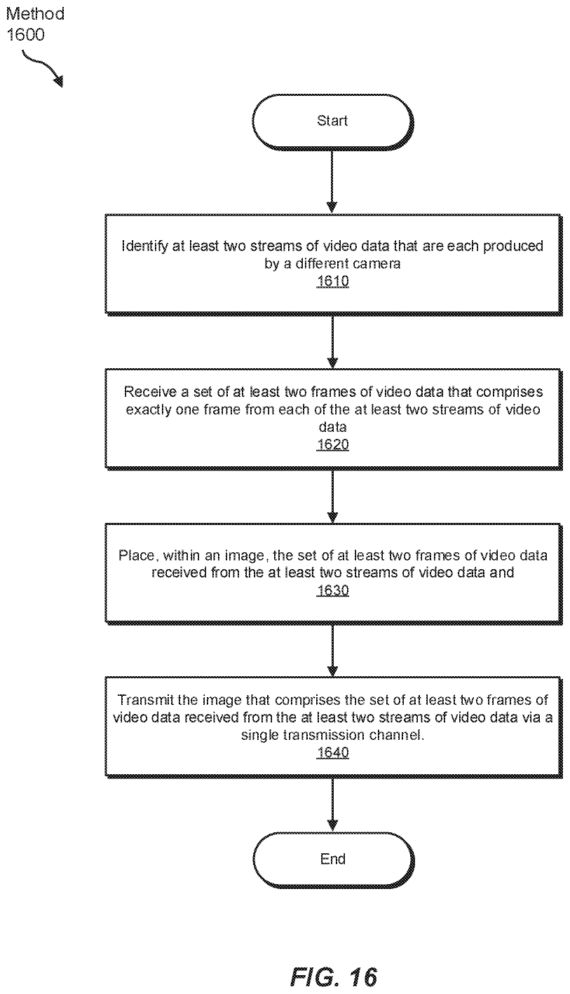

FIG. 16 is a flow diagram of an exemplary method 1600 for efficiently transmitting data received from video cameras. As illustrated in FIG. 16, at step 1610, one or more of the systems described herein may identify at least two streams of video data that are each produced by a different camera. In some examples, the cameras may be mounted on a wearable device such as a head-mounted display. Additionally or alternatively, the cameras may be mounted on another type of device, such as an automobile, drone, and/or any other type of device that has two or more cameras.

In some embodiments, the video cameras may have different exposure lengths, readout start times, and/or readout end times. For example, a first camera may have a shorter exposure length than a second camera, leading to a difference in readout start and/or end time because the first camera finishes recording a frame before the second camera finishes recording a frame. In some embodiment, different cameras may have different exposure lengths because the cameras are performing different functions. For example, a camera that is tracking landmarks to triangulate the location of a wearer of an augmented reality headset may have a longer exposure time than a camera that is tracking a position of a hand-held controller for an augmented reality system due to the comparatively slow change in location of the wearer compared to the faster change in position of the controller. In some examples, cameras may alternate between shorter and longer exposures.

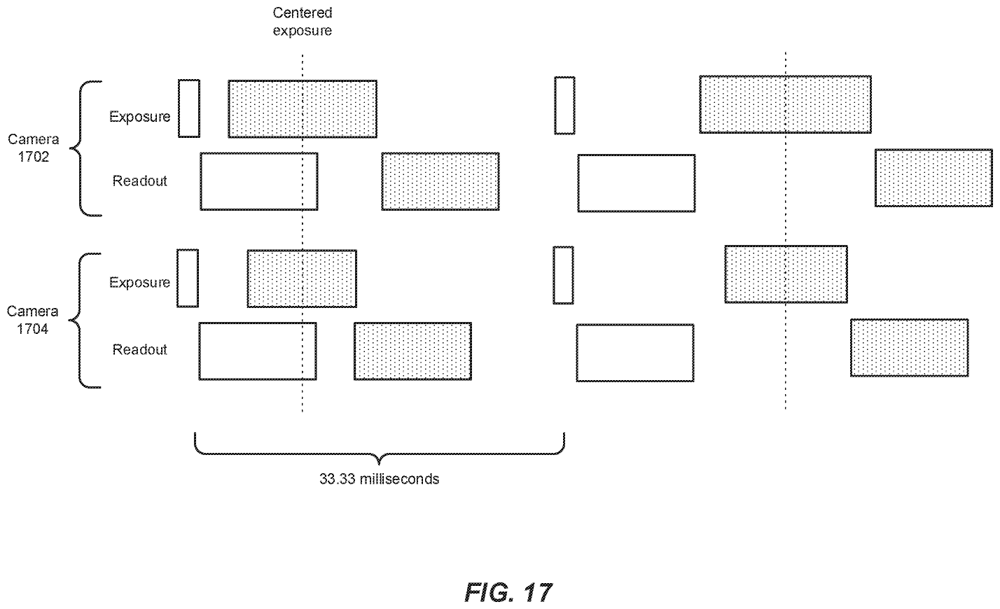

In some examples, cameras may have temporally centered exposures. For example, as illustrated in FIG. 17, a camera 1702 may alternate between short and long exposures, with each readout starting immediately following the end of the exposure. In this example, a camera 1704 may similarly alternate between short and long exposures but may have shorter long exposures than camera 1702. In some examples, the long exposures of cameras 1702 and 1704 may be centered such that each camera reaches the middle of its exposure duration at the same time. By centering the exposure times of multiple cameras, the systems described herein may more effectively collect frames from multiple cameras to place within a single image and/or may minimize the delay in waiting for various cameras to finish exposures without causing temporal gaps in camera coverage.

Returning to FIG. 16, at step 1620, one or more of the systems described herein may receive a set of at least two frames of video data that includes exactly one frame from each of the at least two streams of video data. In some examples, the systems described herein may receive data from more than two cameras and/or the systems described herein may not receive a frame of data from each camera at each interval. For example, if a one camera has a significantly longer exposure than two other cameras, the systems described herein may not receive a frame from the longer-exposure camera during a particular frame-collection interval.

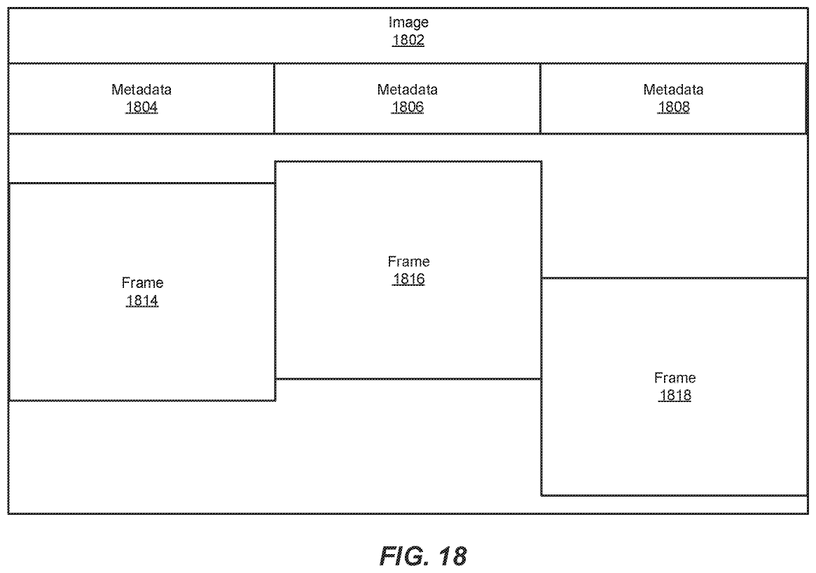

At step 1630, one or more of the systems described herein may place, within an image, the set of at least two frames of video data received from the at least two streams of video data. In some embodiments, the systems described herein may arrange the frames based on one or more characteristics of the frames. For example, the systems described herein may arrange the frames based on the exposure duration and/or readout stand and/or end time of the frame. For example, as illustrated in FIG. 18, image 1802 may include frames 1814, 1816, and/or 1818 arranged in a horizontal line with each frame's vertical placement dictated by readout start time, with frames with earlier readout start times placed higher in the image. In some examples, the systems described herein may also encode metadata as blocks of pixels in the image that are each placed above and/or below the relevant frame. In one example, the systems described herein may encode each bit of metadata as an eight by eight block of pixels. For example, metadata 1804, 1806, and/or 1808 may each correspond to frames 1814, 1816, and/or 1818, respectively. Examples of metadata may include, without limitation, exposure duration, gain settings, timestamp, and/or other suitable camera setting information. In some embodiments, the metadata may include a flag that indicates the function being performed by the camera while recording the frame (e.g., wearer location tracking and/or controller tracker). In some embodiments, the image may be encoded using a standard encoder such as JPEG, BITMAP, and/or GIF.

Returning to FIG. 16, at step 1640, one or more of the systems described herein may transmit the image that includes the set of at least two frames of video data received from the at least two streams of video data via a single transmission channel. In some embodiments, the systems described herein may transmit the image wirelessly. Additionally or alternatively, the systems described herein may transmit the image via a wired connection such as a universal services bus cable. In some embodiments, the systems described herein may transmit the image from one component of a device (such as a head-mounted display) to another component of the same device. Additionally or alternatively, the systems described herein may transmit the image from one device to another device (e.g., a server and/or game console).

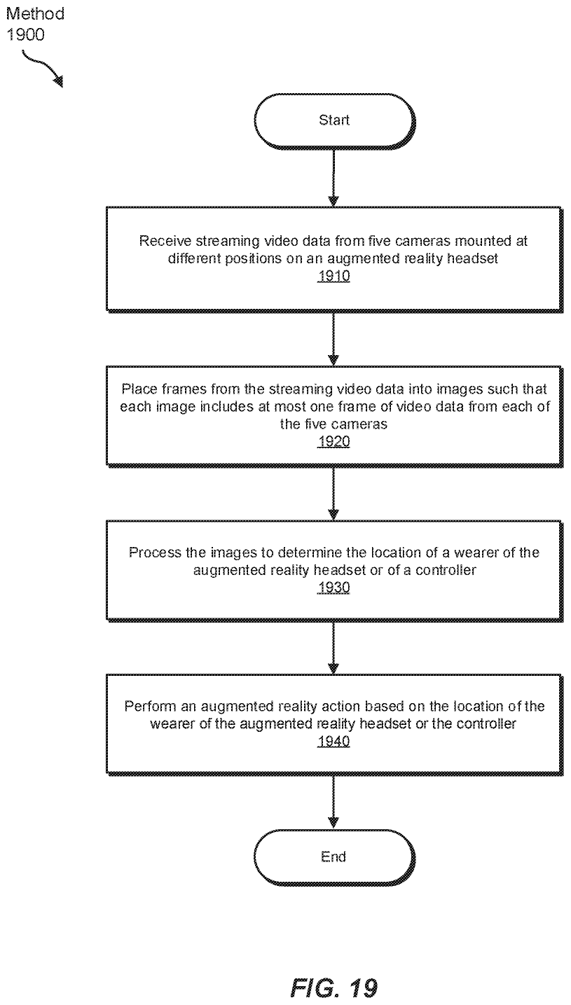

FIG. 19 is a flow diagram of an exemplary method 1900 for processing visual data for wearable head-mounted displays. In some examples, at step 1910, the systems described herein may receive streaming video data from five cameras mounted at different positions on an augmented reality headset. In some examples, different cameras may have different exposure lengths, may be angled at different angles, and/or may be mounted on different parts of the augmented reality headset. At step 1920, the systems described herein may place frames from the streaming video data into images such that each image includes at most one frame of video data from each of the five cameras. In some examples, the systems described herein may arrange the frames based on exposure length and/or include metadata in the image. At step 1930, the systems described herein may process the images to determine the location of a wearer of the augmented reality headset and/or of a controller. In some examples, the systems described herein may reassemble one or more video streams from a series of images that each includes video frames. Additionally or alternatively, the systems described herein may analyze the frames within the images. At step 1940, the systems described herein may perform an augmented reality action based on the location of the wearer of the augmented reality headset or the controller. For example, the systems described herein may trigger an augmented reality object to appear, disappear, move, and/or change.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data into instructions to an array of pixels, output a result of the transformation to display the image on the array of pixels, use the result of the transformation to display an image and/or video, and store the result of the transformation to create a record of displayed image and/or video. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

Embodiments of the instant disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An apparatus comprising:
a head-mounted display comprising:
four lateral cameras comprising:
a camera that is mounted on a right side of the head-mounted display;
a camera that is mounted on a left side of the head-mounted display;
a camera that is mounted on a front of the head-mounted display and is right of a center of the front of the head-mounted display; and
a camera that is mounted on the front of the head-mounted display and is left of a center of the front of the head-mounted display;
one central camera that is mounted on the front of the head-mounted display; and
at least one display surface that displays visual data to a wearer of the head-mounted display.

2. The apparatus of claim 1, wherein:
the camera that is mounted on the left side of the head-mounted display is angled downward relative to the camera that is mounted on the front of the head-mounted display and is left of a center of the front of the head-mounted display; and
the camera that is mounted on the right side of the head-mounted display is angled downward relative to the camera that is mounted on the front of the head-mounted display and is right of a center of the front of the head-mounted display.

3. The apparatus of claim 1, wherein the central camera is mounted on the head-mounted display via a non-rigid mounting.

4. The apparatus of claim 3, wherein:
the four lateral cameras are mounted on the head-mounted display via at least one rigid mounting; and
a field of view of the four lateral cameras overlaps with a field of view of the central camera; and
the head-mounted display sends data from the field of view of the four lateral cameras to a system that corrects visual disturbances caused by the non-rigid mounting of the central camera using the data from the field of view of the four lateral cameras that overlaps with the field of view of the central camera.

5. The apparatus of claim 1, wherein the four lateral cameras are mounted on the head-mounted display via a rigid mounting bracket.

6. The apparatus of claim 1, wherein:
the display surface of the head-mounted display displays the visual data to the wearer based at least in part on a position of the head-mounted display within a physical environment; and
at least one of the four lateral cameras and the central camera captures visual environmental data that indicates the position of the head-mounted display within the physical environment.

7. The apparatus of claim 1, wherein at least one of the four lateral cameras and the central camera tracks the position of a controller operated by the wearer of the head-mounted display.

8. The apparatus of claim 1, wherein at least one of the four lateral cameras and the central camera tracks the position of at least one hand of the wearer of the head-mounted display.

9. The apparatus of claim 1, wherein each of the four lateral cameras is mounted parallel to a surface of the head-mounted display to which the camera is mounted.

10. The apparatus of claim 1, wherein:
the front of the head-mounted display at least partially covers a face of the wearer of the head-mounted display;
the right side of the head-mounted display is adjacent to the front of the head-mounted display; and
the left side of the head-mounted display is adjacent to the front of the head-mounted display opposite the right side of the head-mounted display.

11. The apparatus of claim 1, wherein the central camera is mounted higher on the front of the head-mounted display than the camera that is mounted on the front of the head-mounted display and is left of a center of the front of the head-mounted display.

12. A system comprising:
a head-mounted display comprising:
five cameras that comprise:
four lateral cameras comprising:
a camera that is mounted on a right side of the head-mounted display;
a camera that is mounted on a left side of the head-mounted display;
a camera that is mounted on a front of the head-mounted display and is right of a center of the front of the head-mounted display; and
a camera that is mounted on a front of the head-mounted display and is left of a center of the front of the head-mounted display; and
one central camera that is mounted on a front of the head-mounted display; and
at least one display surface that displays visual data to a wearer of the head-mounted display; and
an augmented reality system that receives visual data input from at least one of the five cameras and sends visual data output to the display surface of the head-mounted display.

13. The system of claim 12, wherein the augmented reality system receives the visual data input from the at least one of the five cameras and sends the visual data output to the display surface of the head-mounted display by:
combining streaming visual data input received from all five of the five cameras into combined visual data; and
displaying at least a portion of the combined visual data on the display surface of the head-mounted display.

14. The system of claim 12, wherein the augmented reality system:
identifies a controller apparatus within the visual data input;
determines, based on at least one visual cue within the visual data input, a position of the controller apparatus relative to the wearer of the head-mounted display; and
performs an augmented reality action based at least in part on the position of the controller apparatus relative to the wearer of the head-mounted display.

15. The system of claim 12, wherein the augmented reality system:
identifies a physical location cue within visual data input from at least two cameras of the five cameras;
determines a physical location of the wearer of the head-mounted display based at least in part on triangulating the physical location cue within the visual data input from the at least two cameras; and
performs an augmented reality action based at least in part on the physical location of the wearer of the head-mounted display.

16. The system of claim 12, wherein the augmented reality system receives the visual data input from the at least one of the five cameras by:
receiving visual data from the central camera that comprises a visual disturbance due to a non-fixed mounting of the central camera;
receiving visual data from at least one of the four lateral cameras that does not comprise the visual disturbance due to a fixed mounting of the at least one of the four lateral cameras; and
correcting for the visual disturbance in the visual data from the central camera using the visual data from the at least one of the four lateral cameras.

17. The system of claim 12, wherein the augmented reality system:
identifies a first controller apparatus and a second controller apparatus;
determines that the first controller apparatus is visually occluded by the second controller apparatus in visual data input from one camera of the five cameras;
determines that the first controller apparatus is not visually occluded by the second controller apparatus in visual data input from a different camera of the five cameras;
determines a position of the first controller apparatus based at least in part on visual data from the different camera; and
performs an augmented reality action based at least in part on the position of the first controller apparatus.

18. The system of claim 12, wherein, for each camera within the five cameras, a field of view of the camera overlaps at least partially with a field of view of at least one additional camera within the five cameras.

19. A computer-implemented method for motion tracking head-mounted displays, at least a portion of the method being performed by a computing device comprising at least one processor, the method comprising:
identifying a head-mounted display that comprises five cameras, wherein one of the five cameras is attached to a right side of the head-mounted display, one of the five cameras is attached to a left side of the head-mounted display, one of the five cameras is attached to centrally on a front of the head-mounted display, and two of the five cameras are attached laterally on the front of the head-mounted display;
capturing, via at least one camera of the five cameras, visual data of a physical environment surrounding a wearer of the head-mounted display;
determining, based on the visual data of the physical environment captured by the at least one camera, a position of the wearer of the head-mounted display relative to the physical environment; and
performing an action based on the position of the wearer of the head-mounted display relative to the physical environment.

20. The computer-implemented method of claim 19, further comprising:
determining, based on the visual data of the physical environment captured by the at least one camera, a position of a controller apparatus; and
performing an action based on the position of the controller apparatus.
